(19) United States
(12) Patent Application Publication
(10) Pub. No.: US 2024/0211510 A1
(43) Pub. Date: Jun. 27, 2024

(54) FEW-SHOT LEARNING METHOD AND IMAGE PROCESSING SYSTEM USING THE SAME

(71) Applicant: POSTECH RESEARCH AND BUSINESS DEVELOPMENT FOUNDATION, Pohang-si (KR)

(72) Inventors: Min Su CHO, Pohang-si (KR); Da Hyun KANG, Pohang-si (KR)

(73) Assignee: POSTECH RESEARCH AND BUSINESS DEVELOPMENT FOUNDATION, Pohang-si (KR)

(21) Appl. No.: 18/396,400

(22) Filed: Dec. 26, 2023

(30) Foreign Application Priority Data
Dec. 27, 2022 (KR) 10-2022-0186054
Aug. 17, 2023 (KR) 10-2023-0107891

(51) Int. Cl. G06F 16/583; G06F 16/532; G06F 16/55; G06T 7/10

(52) U.S. Cl. CPC G06F 16/583; G06F 16/532; G06F 16/55; G06T 7/10

(57) ABSTRACT

A few-shot learning method according to the present disclosure includes obtaining an image and a segmentation prediction for the image and learning, when a query image is provided with a pre-learned model, the model based on the image and a segmentation index to simultaneously perform classification and segmentation of a specific region from the query image, in which the model includes an attentive squeeze network (ASNet), does not perform the classification when an object with low relevance exists in the query image, and performs the classification and segmentation when an object with high relevance exists in the query image.

### CROSS REFERENCE TO RELATED APPLICATION

This application claims the benefit of Korean Patent Application Nos. 10-2022-0186054, filed on Dec. 27, 2022 and 10-2023-0107891, filed on Aug. 17, 2023, the contents of which are all hereby incorporated by reference herein in their entirety.

### BACKGROUND

### Field

The present disclosure relates to a few-shot learning method and an image processing system using the same, and more specifically, relates to a few-shot learning method of a model that performs processing of a query image and an image processing system using the same.

### Related Art

In general, few-shot learning is a learning method to correctly predict a query image with small learning data (support set). Due to the advantage of few-shot learning that high performance can be achieved with small learning data, various research is being conducted in the field of computer vision. This few-shot learning aims to classify the query images into target classes. In other words, the few-shot learning may be a method of learning which target class the query image is, rather than learning which target class the query image belongs to.

For example, the few-shot learning can be divided into a few-shot classification technology and a few-shot segmentation technology. The few-shot classification technology aims to classify query images into target classes. In other words, the query image can be classified into the target class when a support set of several examples for the target class is given. Moreover, the few-shot segmentation technology aims to divide a target area of the query image into settings similar to the target class. However, in conventional few-shot learning, research and development have been conducted separately so far, even though the few-shot classification technology and the few-shot segmentation technology are closely related to each other.

In addition, there is a problem in that it is difficult to reflect the few-shot classification technology and the few-shot segmentation technology together in reality. The few-shot classification technology assumes that the query contains one of the target classes. However, although the few-shot segmentation technology allows multiple classes, there is a problem in that it cannot perform processing when there is no target class in the segmentation.

### SUMMARY

A purpose of the present disclosure is to provide a few-shot learning method and an image processing system using the same that allow a model to identify a subset that appears in a query image and predict a set of problem segmentation masks corresponding to a class when the query image is given.

According to an aspect of the present disclosure, there is provided a few-shot learning method including: obtaining an image and a segmentation prediction for the image; and learning, when a query image is provided with a pre-learned model, the model based on the image and a segmentation index to simultaneously perform classification and segmentation of a specific region from the query image, in which the model includes an attentive squeeze network (ASNet), does not perform the classification when an object with low relevance exists in the query image, and performs the classification and segmentation when an object with high relevance exists in the query image.

An integrative few-shot learning (iFSL) method may be applied to the learning of the model, and in the integrative few-shot learning, the model may be learned to identify a subset appearing in the query image and predict a set of problem segmentation masks corresponding to the class.

The model may calculate a correlation tensor between a plurality of images and generate a classification map by passing the correlation tensor through a strided self-attention layer.

The ASNet may include an attentive squeeze layer (AS layer), and the AS layer may be prepared as a high-order self-attention layer and return a correlation expression of different levels based on the correlation tensor.

The ASNet may have, as input, hyper-correlation which is a pyramid-shaped cross-correlation tensor between the query image and the support image.

In integrated few-shot learning, inference may be performed using max pooling.

In the integrated few-shot learning, a classification loss and a segmentation loss may be used, and a learner may be trained using a class tag or a segmentation annotation.

The classification loss may be an average binary cross-entropy between a spatially averaged pooled class score and a correct answer class label.

The segmentation loss may be an average cross-entropy between a class distribution of an individual position and an actual segmentation annotation.

According to another aspect of the present disclosure, there is provided an image processing system comprising a processing module configured to input an externally provided image into a pre-trained model and simultaneously perform classification and segmentation on a specific region from the image, in which in learning of the model, an image and a segmentation prediction for the image are obtained, and when a query image is provided with a pre-learned model, the model is learned based on the image and a segmentation index to simultaneously perform classification and segmentation of a specific region from the query image, and the model includes an attentive squeeze network (ASNet), does not perform the classification when an object with low relevance exists in the query image, and performs the classification and segmentation when an object with high relevance exists in the query image.

An integrative few-shot learning (iFSL) method may be applied to the learning of the model, and in the integrative few-shot learning, the model may be learned to identify a subset appearing in the query image and predict a set of problem segmentation masks corresponding to the class.

The model may calculate a correlation tensor between a plurality of images and generate a classification map by passing the correlation tensor through a strided self-attention layer.

The ASNet may include an attentive squeeze layer (AS layer), and the AS layer may be prepared as a high-order self-attention layer and return a correlation expression of different levels based on the correlation tensor.

The ASNet may have, as input, hyper-correlation which is a pyramid-shaped cross-correlation tensor between the query image and the support image.

In integrated few-shot learning, inference may be performed using max pooling.

In the integrated few-shot learning, a classification loss and a segmentation loss may be used, and a learner may be trained using a class tag or a segmentation annotation.

The classification loss may be an average binary cross-entropy between a spatially averaged pooled class score and a correct answer class label.

The segmentation loss may be an average cross-entropy between a class distribution of an individual position and an actual segmentation annotation.

The few-shot learning method according to the present disclosure and the image processing system using the same are effective for FS-CS, and have high scalability because iFSL can be learned with weak or strong indicators.

The technical effects of the present disclosure as described above are not limited to the effects mentioned above, and other technical effects not mentioned may be clearly understood by those skilled in the art from the description below.

### BRIEF DESCRIPTION OF THE DRAWINGS

FIG. 1 is a conceptual diagram schematically illustrating an image processing system according to the present embodiment.

FIG. 2 is a conceptual diagram illustrating a method of processing an image in the image processing system according to the present embodiment.

FIG. 3 is a conceptual diagram illustrating an attentive squeeze network (ASNet) in an integrated few-shot learning method according to the present embodiment.

FIG. 4 is a classification result obtained by comparing methods different from the image processing system according to the present embodiment using a Pascal dataset in an FS-CS problem.

FIG. 5 is a segmentation result obtained by comparing methods different from the image processing system according to the present embodiment using the Pascal dataset in the FS-CS problem.

FIG. 6 is a diagram illustrating the segmentation results of the ASNet of the image processing system according to the present embodiment.

FIG. 7 is a diagram illustrating performance of four methods evaluated by changing the number of classes N.

FIGS. 8a to 8c are diagrams illustrating models learned in A and evaluated in B to illustrate problem reducibility.

### DESCRIPTION OF EXEMPLARY EMBODIMENTS

Hereinafter, an embodiment of the present disclosure will be described in detail with reference to the attached drawings. However, the present embodiment is not limited to an embodiment disclosed below and may be implemented in various forms, and the present embodiment is provided solely to ensure that the disclosure of the present disclosure is complete and to fully inform those skilled in the art of the scope of the invention. The shapes of elements in the drawings may be exaggerated for a clearer explanation, and elements indicated with the same symbol in the drawings refer to the same elements.

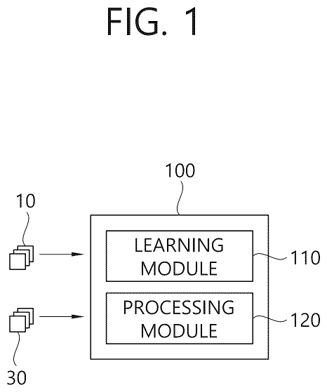

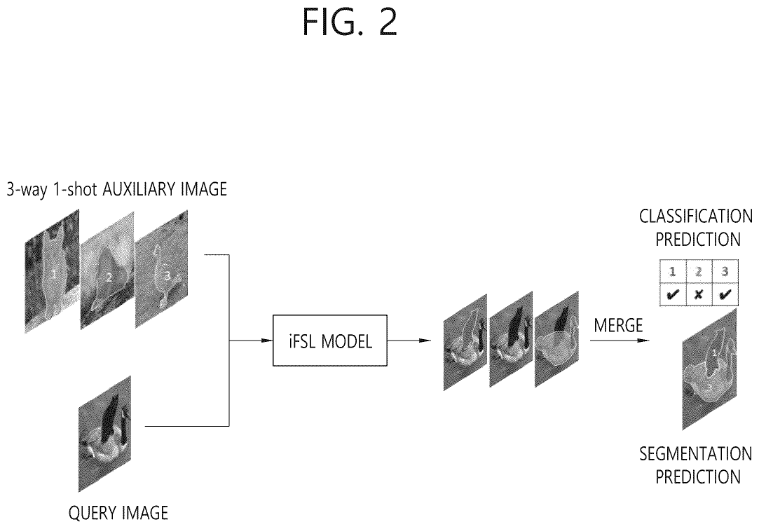

FIG. 1 is a conceptual diagram schematically illustrating an image processing system according to the present embodiment, and FIG. 2 is a conceptual diagram illustrating a method of processing the image in the image processing system according to the present embodiment.

As illustrated in FIGS. 1 and 2, an integrated approach to image classification and segmentation problems using very few image data (Integrative Few-Shot Learning for Classification and Segmentation, FS-CS) is applied to the image processing system according to the present embodiment.

For example, the image processing system 100 may include a learning module 110 and a processing module 120. The learning module 110 learns based on a very small number of images 10 and builds a model to solve the FS-CS problem, which will be explained below. Moreover, the processing module 120 can perform image classification and segmentation when an image 30 for processing is provided based on the model learned by the learning model 110.

The learning module 110 acquires an image and segmentation prediction for the image and performs learning. Accordingly, the learning module 110 allows a model learned through the few-shot learning to solve both classification and segmentation problems at the same time. In other words, when a query image and a support image are given, the learned model can be trained to identify the existence of an object corresponding to each class and predict a segmentation mask for the object location.

As an example, assuming a target class set C including N classes of interest and K example images for each N target class, a correct answer index y is the presence or absence of the class (weak label, weak indicator) or a segmentation mask correct answer (strong label, strong indicator) and can be selected according to the situation of the given indicator. Accordingly, when a query image x is given, the model must identify a subset of target classes y that appears in the query image and at the same time predict a set of object segmentation masks Y corresponding to that class.

Accordingly, when the query image is given as the model, integrative few-shot learning (iFSL) is applied to the learning model 110 so that the model identifies a subset that appears in the query image and predicts a problem segmentation mask set corresponding to the class. This integrated few-shot learning method allows the model to simultaneously perform classification and segmentation with a small number of images.

For example, an integrated few-shot learner f receives the query image x and a support image S as input, and outputs an object segmentation mask Y for each class. The set of segmentation masks Y includes Y(n)∈RH×W for N classes, as illustrated in Equation 1 below.

$$Y = f ( x , S ; θ ) ∈ {R}^{H \times W \times N} \qquad [ Equation 1 ]$$

Here, H×W represents the size of each mask map, and θ is a parameter for meta learning. Moreover, the output of each location on the map indicates the probability of being located in the object area of that class.

The integrated few-shot learning method performs inference on the shared segmentation mask Y for both the presence/absence of each class and the class segmentation mask. The multi-hot vector of occurrence for each class is predicted as illustrated in Equation 2 below.

$${\hat{y}}_{C}^{( n )} = \{ \begin{matrix}1 & if {max}_{p ∈ [ H ] \times [ W ]} {Y}^{( n )} ( p ) \geq δ , \\ 0 & otherwise\end{matrix} , \qquad [ Equation 2 ]$$

Here, p represents a 2D position. Moreover, δ is the threshold, [k] is the set of integers from 1 to k, that is, [k]={1, 2, . . . , k}.

In general, since inference using average pooling is prone to missing small objects in multi-label classification, the integrated few-shot learning method performs the inference using max pooling. The class detected at any position within the shared segmentation mask indicates the presence of the class.

Meanwhile, a split class probability mask is derived from a class-specific object prediction mask under a pixel class exclusive attribute. Pixels are always classified into a unique class among N object classes and foreground classes. Since the foreground class is not explicitly given, a separate foreground example class is required. Accordingly, the integrated few-shot learning method averages n object class maps when estimating the foreground class map, calculates the episodic foreground map Ybg as illustrated in Equations 3 and 4 below, and connects the episodic foreground map to the foreground map for each class to obtain the division probability tensor Ys.

$${Y}_{bg} = \frac{1}{N} {\sum }_{n = 1}^{N} ( 1 - {Y}^{( n )} ) , \qquad [ Equation 3 ]$$

$${Y}_{S} = [ Y \vert {Y}_{bg} ] ∈ {ℝ}^{H \times W \times ( N + 1 )} \qquad [ Equation 4 ]$$

The final segmentation mask \dot{Y}_{S}∈R^{H×W} is predicted by selecting the class with the highest probability value from the probability distribution, as illustrated in Equation 5 below.

$${\hat{Y}}_{S} = {arg max}_{n ∈ [ N + 1 ]} {Y}_{S} . \qquad [ Equation 5 ]$$

Meanwhile, the integrated few-shot learning method uses a classification loss and a segmentation loss, and the learner can be trained using class tag or segmentation annotation.

The classification loss is formulated as Equation 6 below as the average binary cross-entropy between the spatially averaged pooled class score and the correct answer class label. Here, y_{gt} represents a multi-hot vector.

$${ℒ}_{C} = - \frac{1}{N} {\sum }_{n = 1}^{N} {y}_{gt}^{( n )} log \frac{1}{HW} {\sum }_{p ∈ [ H ] \times [ W ]} {Y}^{( n )} ( p ) , \qquad [ Equation 6 ]$$

Moreover, the segmentation loss is formulated as the average cross-entropy between the class distribution of the individual position and the actual segmentation annotation, as illustrated in Equation 7 below. Here, y_{gt} represents the ground truth segmentation mask.

$${ℒ}_{S} = - \frac{1}{( N + 1 )} \frac{1}{HW} {\sum }_{n = 1}^{N + 1} {\sum }_{p ∈ [ H ] \times [ W ]} {Y}_{gt}^{( n )} ( p ) log {Y}_{S}^{( n )} ( p ) , \qquad [ Equation 7 ]$$

The classification loss and segmentation loss share a similar goal such as classification. However, there is a difference in whether to classify each image or each pixel. Therefore, a learning objective can use one of the losses depending on the given level of train supervision. In other words, it can be selected depending on whether a weak label or a strong label can be used.

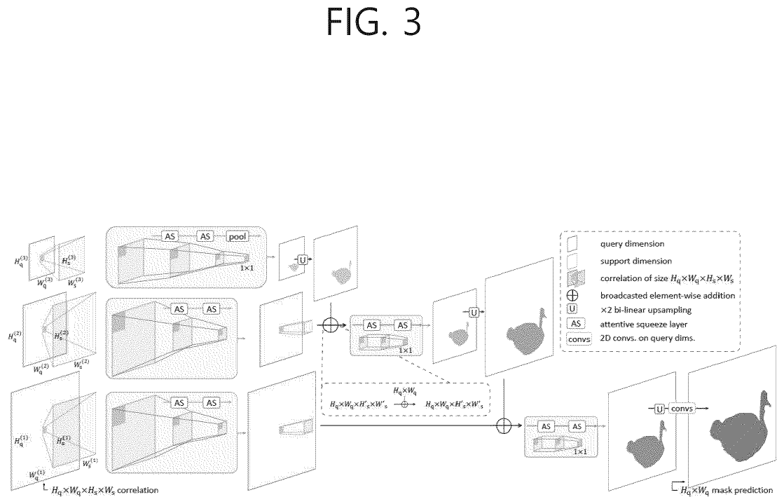

FIG. 3 is a conceptual diagram illustrating an attentive squeeze network (ASNet) in the integrated few-shot learning method according to the present embodiment.

As illustrated in FIG. 3, the integrated few-shot learning method according to the present embodiment uses the attentive squeeze network (ASNet).

The ASNet does not perform classification by classifying the image as “unrelated” when an object with no relevance exists in the query image, but classifies the image as “relevant” when an object with high relevance exists and perform the classification and segmentation on the object.

The ASNet can be prepared by calculating the correlation tensor between a plurality of images and passing the calculated correlation tensor through a strided self-attention layer to generate a classification map. The main component of this ASNet is an attentive squeeze layer (AS Layer). The AS Layer is a high-order self-attention layer that returns correlation expressions of different levels based on the correlation tensor. This ASNet has a pyramid-shaped cross-correlation tensor between the query image and the support image, that is, hyper-correlation, as input.

The pyramid correlations are fed to the pyramid AS Layer, which progressively compresses the spatial dimensions of the support images, and the pyramid outputs are merged into the final foreground map via a bottom-up path.

As illustrated in FIG. 2, the N-way output map is calculated and collected in parallel to prepare a foreground map for each class in Equation 1 and apply the foreground map to the integrated few-shot learning method.

Looking more specifically at the structure of the ASNet, the ASNet builds the hyper-correlation with an image feature map between query (red in FIG. 2) and support (blue in FIG. 2). Here, the 4D correlation is represented by two 2D squares.

The ASNet can learn a method for converting the correlation into the foreground map by gradually compressing the support dimension for each query dimension through global self-attention. However, in FIG. 2, the channel dimensions of input correlation, intermediate feature, and output foreground map are omitted.

Meanwhile, looking at the hyper-correlation structure, the ASNet can learn a method for configuring hyper-correlation between the query image and support image and generating a foreground segmentation mask for each support input.

For example, in order to prepare an input hyper-correlation, an episode, that is, a set of query images and support images, is enumerated into a list of pairs of query image, support image, and support label.

Here, the input image is fed to a stacked convolutional layer of a convolutional neural network (CNN), and mid- and high-level output feature maps are collected to build a feature pyramid {F^{(t)}}_{l=I}^{L}. Here, L represents the index (bottleneck layer of ResNet50) of the unit layer. Then, the cosine similarity between feature maps in the query and support feature pyramid pairs is calculated to obtain a 4D correlation tensor of H_{q}^{(t)}×W_{q}^{(t)}×Hₛ^{(t)}×Wₛ^{(t)} size, and ReLU (Rectified Linear Unit) is used as illustrated in Equation 8 below.

$$C \text{?} ( {p}_{q} , {p}_{s} ) = ReLU ( \frac{F \text{?} ( {p}_{q} ) \cdot F \text{?} ( {p}_{s} )}{‖ F \text{?} ( {p}_{q} ) ‖ ‖ F \text{?} ( {p}_{s} ) \text{?} ‖} ) . \qquad [ Equation 8 ]$$

$$\text{?} \text{indicates text missing or illegible when filed}$$

These L correlation tensors are grouped into P groups of the same spatial size, and the tensors in each group are connected along a new channel dimension to implement a super-correlation pyramid.

In {C^{(p)}|C^{(p)}∈ [symbol] ^{H}^{_{q}}^{^{(p)}}^{×W}^{_{q}}^{^{(p)}}^{×H}^{ₛ}^{^{(p)}}^{×W}^{ₛ}^{^{(p)}}^{×C}^{ᵢₙ}^{^{(p)}}}ₚ₌₁^{P}, the channel size Cᵢₙ^{(p)} corresponds to the number of connected tensors in the Pth group. The first two spaces [symbol] ^{H}^{_{q}}^{×W}^{_{q}} of the correlation tensor are used as query dimensions, and the last two spaces [symbol] ^{H}^{ₛ}^{×W}^{ₛ} are used as support dimensions.

Meanwhile, looking at the AS Layer, the AS Layer converts the correlation tensor into another tensor with a smaller support dimension through strided self-attention. Here, the tensor can be recast as a matrix where each element represents a support pattern. For example, when a correlation tensor C(X_{q})∈ [symbol] ^{H}^{ₜ}^{×W}^{ₛ}^{×C}^{ᵢₙ} is given in a super-correlation pyramid, the correlation tensor is reconstructed into a block matrix of H_{q}×W_{q} size, and each element is reconstructed into a block matrix of the same size as Equation 9 corresponding to the correlation tensor of C(X_{q})∈ [symbol] ^{H}^{ₛ}^{×W}^{ₛ}^{×C}^{ᵢₙ} at the query position x_{q}.

$${C}^{block} = [ \begin{matrix}C ( ( 1 , 1 ) ) & … & C ( ( 1 , {W}_{q} ) ) \\ ⋮ & ⋱ & ⋮ \\ C ( ( {H}_{q} , 1 ) ) & … & C ( ( {H}_{q} , {W}_{q} ) )\end{matrix} ] . \qquad [ Equation 9 ]$$

The goal of the AS Layer is to analyze the global context of each support tensor and extract a reduced correlation expression of the support dimensions while maintaining the query dimension ( [symbol] ^{H}^{_{q}}^{×W}^{_{q}}^{×H}^{ₛ}^{×W}^{ₛ}^{×C}^{ᵢₙ}→ [symbol] ^{H}^{_{q}}^{×W}^{_{q}}^{×H′}^{ₛ}^{×W′}^{ₛ}^{×C}^{ₒᵤₜ}). Here, H′ₛ is less than or equal to Hₛ, and is less than or equal to W′ₛ.

Moreover, the AS Layer applies the Global Self attention mechanism to correlations to learn the overall pattern of the support correlations. Here, self-attention weights are shared across all query locations and can be processed in parallel.

At this time, since all locations share the calculation below, the support correlation tensor for all query locations xq can be expressed as C^{s}=C^{block}(xq) In the self-attention operation, the support correlation tensor C^{s} is embedded in the target, key, and value triplet like T, K, V∈ [symbol] ^{H′}^{ₛ}^{×W′}^{ₛ}^{×C}^{ᵢₙ}. Here, the output size can be controlled using three convolutions with strides greater than or equal to 1.

Afterwards, the attention context is calculated using T and K which are the resulting target and the main correlation expressions. The attention context can be calculated by matrix multiplication in Equation 10 below.

$$A = {TK}^{⊤} ∈ ℝ \text{?} . \qquad [ Equation 10 ]$$

$$\text{?} \text{indicates text missing or illegible when filed}$$

Afterwards, when the selection of the main foreground location can lead to more in the foreground area, the attention context is normalized by Softmax so that it is summed to 1, which masks the attention value by the support mask annotation Yₛ, as illustrated in Equation 11 below.

$$A \text{?} ( p \text{?} , p \text{?} ) = \frac{exp ( A ( p \text{?} , p \text{?} ) Y \text{?} ( p \text{?} )}{\sum \text{?} exp ( A ( p \text{?} , {p}_{k}^{′} ) Y \text{?} ( {p}_{k}^{′} )} , \qquad [ Equation 11 ]$$

$$Y \text{?} ( {p}_{k} ) = \{ \begin{matrix}1 & if {p}_{k} ∈ [ H \text{?} ] \times [ W ] is foreground , \\ - ∞ & otherwise\end{matrix} \text{?}$$

$$\text{?} \text{indicates text missing or illegible when filed}$$

Moreover, using the masked attention context Ā, the value including V can be aggregated as illustrated in Equation 12 below.

$$C \text{?} = A \text{?} V ∈ ℝ \text{?} \qquad [ Equation 12 ]$$

$$\text{?} \text{indicates text missing or illegible when filed}$$

Here, the attended representation is fed to the MLP layer Wₒ and added to the input. In cases where the input and output dimensions do not match, the input is selectively fed to the convolution layer W₁. Moreover, an activation layer φ(·) consisting of group normalization and ReLU activation is added as illustrated in Equation 13.

$$\text{?} \qquad [ Equation 13 ]$$

$$\text{?} \text{indicates text missing or illegible when filed}$$

The output is supplied as illustrated in Equation 14 to another MLP that completes the unit operation of the AS Layer.

$$\text{?} \qquad [ Equation 14 ]$$

$$\text{?} \text{indicates text missing or illegible when filed}$$

Here, the corresponding position can be included in the block matrix of Equation 9. The AS Layer can gradually reduce the size of the support correlation tensor H′ₛ×W′ₛ by performing stacking.

Meanwhile, looking multi-layer fusion of the ASNet, the pyramid correlation representation performs pairwise operations computationally and can be merged from the coarsest level to the most detailed level. First, a mixed representation C^{mix} can be obtained by bilinear up-sampling the lowest correlation representation to the adjacent previous query space dimension and adding the two representations. The mixed representation is then fed to two sequential AS Layers until the size becomes a point feature of H′ₛ=W′ₛ=1 and then fed into pyramid fusion. Here, the output of the fastest fusion layer is fed to a convolutional decoder, which consists of interleaved 2D convolution and bilinear up-sampling to map C-dimensional channels to foreground and background and output space size to input query image size.

Moreover, looking at the foreground map calculation for each class, a mask prediction for each class can be generated by calculating the average of the K-shot output foreground activation maps. The averaged output map is normalized with softmax for both channels of the binary segmentation map. Moreover, the foreground probability prediction Y⁽ⁿ⁾∈ [symbol] ^{H×W} can be obtained by normalizing the two channels of the segmentation map with softmax.

Accordingly, when the learning module learns the model and the learned model is given as the query image, the model identifies the subset that appears in the query image and predicts the problem segmentation mask set corresponding to the class.

These models can be installed in a later processing module, and when the image for processing is provided, the processing module may identify the subset that appears in the query image and predict the problem segmentation mask set corresponding to the class to perform classification and segmentation on the specific region.

Meanwhile, hereinafter, model experiments using the few-shot learning method according to the present embodiment will be described in detail.

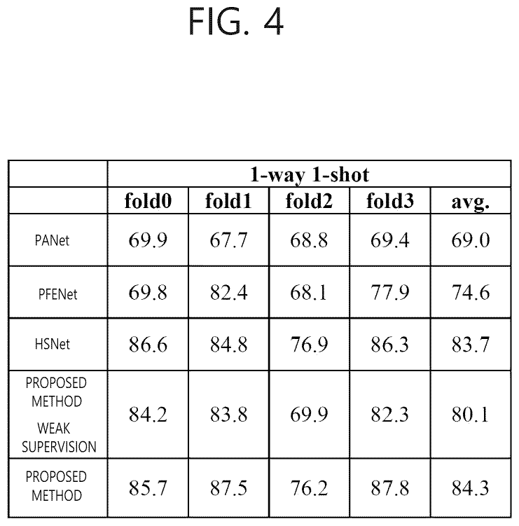

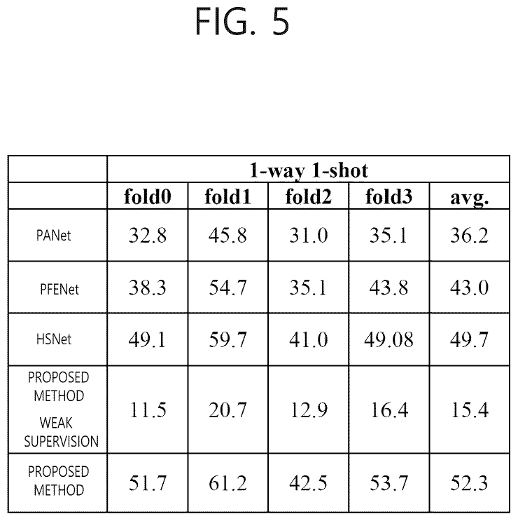

FIG. 4 is a classification result obtained by comparing methods different from the image processing system according to the present embodiment using a Pascal dataset in the FS-CS problem, and FIG. 5 is a segmentation result obtained by comparing methods different from the image processing system according to the present embodiment using the Pascal dataset in the FS-CS problem.

As illustrated in FIGS. 4 and 5, in the model experiment according to the present embodiment, an iFSL framework for the integrated few-shot learning method for the FS-CS problem can be evaluated. Experiments were performed using Pascal and Rsenet, and were evaluated in a 1-way 1-shot setup unless otherwise specified.

In the experiment, the iFSL framework for FS-CS was verified, and the performance of the proposed model was compared with that of three models (PASNet, PFENet, and HSNet). Three models were proposed for existing FS-S tasks, and all models were trained on iFSL to ensure a fair comparison.

The iFSL framework is quantitatively verified in the FS-CS problem, and it can be seen that the proposed method outperforms other methods in terms of not only segmentation performance but also few-shot classification. FIG. 4 illustrates the classification results obtained by comparing the methods different from the image processing system 100 using the Pascal-5 dataset in the FS-CS problem. In this case, all methods were learned through the strong indicator learning method of the iFSL, and only the proposed method-weakly supervised method was learned using the weakly supervised method. Moreover, FIG. 5 illustrates the segmentation results obtained by comparing the methods different from the image processing system 100 in the FS-CS problem using the Pascal-5 experimental environment.

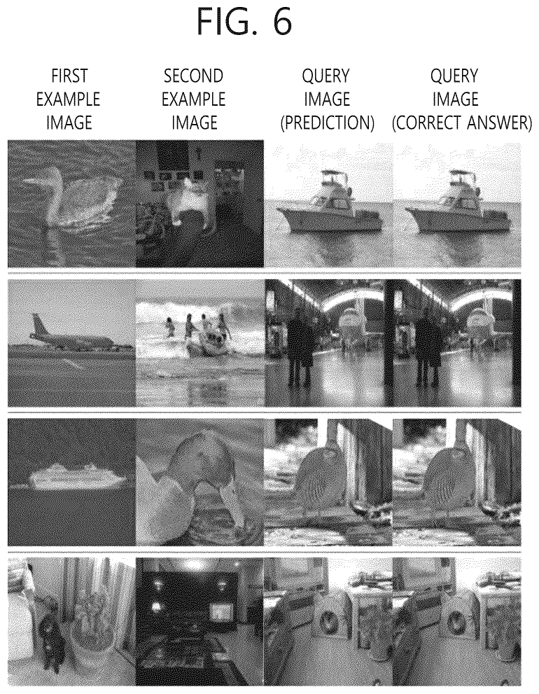

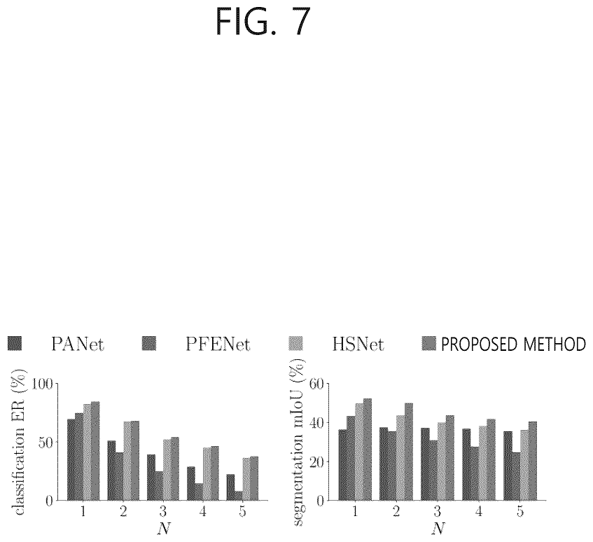

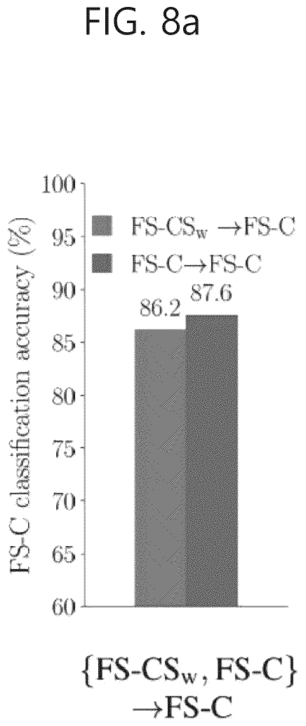

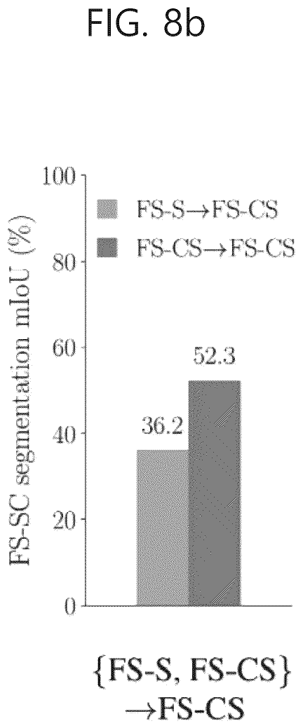

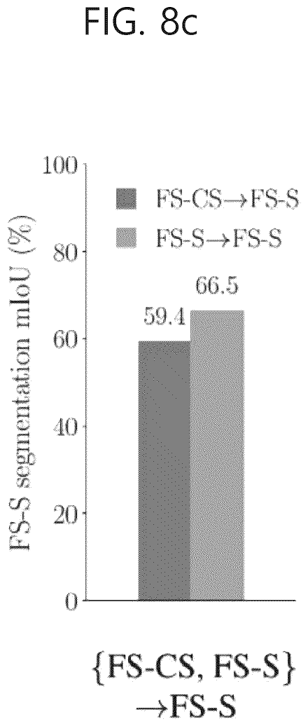

FIG. 6 is a diagram illustrating the segmentation results of the ASNet of the image processing system according to the present embodiment. FIG. 7 is a diagram illustrating the performance of four methods evaluated by changing the number of classes N, and FIGS. 8a to 8c are diagrams illustrating models learned in A and evaluated in B to illustrate problem reducibility.

As with the segmentation performance illustrated in FIGS. 6 to FIGS. 8a to 8c, it can be seen that the iFSL framework appropriately segments objects in the query image by referring to the example image.

Meanwhile, the FS-CS can be extended to multi-class problems with an arbitrary number of classes. FIG. 5 compares the FS-CS performance of four methods by comparing the number of classes in the example image from 1 to 5. From FIG. 7, it can be seen that the proposed method consistently illustrates better performance than other methods even when the number of classes is diverse.

Meanwhile, evaluating the reducibility between the FS-CS, FS-C, and FS-S problems illustrates that FS-CS encompasses and generalizes the two existing problems. As illustrated in FIGS. 8a to 8c, FS-S→FS-CS illustrates the results of the model learned in the FS-S problem being evaluated in the FS-CS setting. In this experiment, only data that met the constraints on the occurrence of example classes were selected and evaluated to construct a problem environment for FS-C or FS-S. In the case of FS-C, class information (weak indicators) was used. All other settings were the same, and ResNet50 from the Pascal-i dataset was used.

The results illustrate that the models learned with FS-CS, that is, FS-CS, are learned, and the shortcomings of the existing FS-C are overcome with the motivation being reducible to the existing FS-C. The few-shot classification task, that is, the reducibility between FS-C and FS-CSW, is presented in FIG. 8a. In this setting, the FS-CSW model is trained for multi-metric classification but is evaluated by predicting the higher-class response between two classes. The FS-CS model competes closely with the FS-C model in terms of classification accuracy. In contrast, it can be seen that the reducibility between the segmentation operations FS-S and FS-CS results in asymmetric results as illustrated in FIGS. 8b and 8c. It can be seen that the FS-CS model illustrates relatively small performance degradation in FS-S. However, FS-Slearner illustrates serious performance degradation. According to qualitative results, the FS-S model predicts false positives, and in contrast, the FS-CS model can successfully segment objects because they identify both example images and class relevance.

Accordingly, the integrated few-shot learning method according to the present disclosure and the image processing system using the same are effective for FS-CS, and have a higher scalability because the iFSL can learn with weak or strong indicators.

An embodiment of the present disclosure described above and illustrated in the drawings should not be construed as limiting the technical idea of the present disclosure. The scope of protection of the present disclosure is limited only by the matters stated in the claims, and a person with ordinary knowledge in the technical field of the present disclosure can improve and change the technical idea of the present disclosure into various forms. Therefore, these improvements and changes will fall within the scope of protection of the present disclosure as long as they are obvious to a person with ordinary knowledge.

What is claimed is:

1. A few-shot learning method comprising:
obtaining an image and a segmentation prediction for the image; and
learning, when a query image is provided with a pre-learned model, the model based on the image and a segmentation index to simultaneously perform classification and segmentation of a specific region from the query image,
wherein the model includes an attentive squeeze network (ASNet), does not perform the classification when an object with low relevance exists in the query image, and performs the classification and segmentation when an object with high relevance exists in the query image.

2. The few-shot learning method of claim 1, wherein an integrative few-shot learning (iFSL) method is applied to the learning of the model, and
in the integrative few-shot learning, the model is learned to identify a subset appearing in the query image and predict a set of problem segmentation masks corresponding to the class.

3. The few-shot learning method of claim 1, wherein the model calculates a correlation tensor between a plurality of images and generates a classification map by passing the correlation tensor through a strided self-attention layer.

4. The few-shot learning method of claim 3, wherein the ASNet includes an attentive squeeze layer (AS layer), and
the AS layer is prepared as a high-order self-attention layer and returns a correlation expression of different levels based on the correlation tensor.

5. The few-shot learning method of claim 4, wherein the ASNet has, as input, hyper-correlation which is a pyramid-shaped cross-correlation tensor between the query image and the support image.

6. The few-shot learning method of claim 2, wherein in integrated few-shot learning, inference is performed using max pooling.

7. The few-shot learning method of claim 2, wherein in the integrated few-shot learning, a classification loss and a segmentation loss are used, and a learner is trained using a class tag or a segmentation annotation.

8. The few-shot learning method of claim 7, wherein the classification loss is an average binary cross-entropy between a spatially averaged pooled class score and a correct answer class label.

9. The few-shot learning method of claim 7, wherein the segmentation loss is an average cross-entropy between a class distribution of an individual position and an actual segmentation annotation.

10. An image processing system comprising a processing module configured to input an externally provided image into a pre-trained model and simultaneously perform classification and segmentation on a specific region from the image,
wherein in learning of the model,
an image and a segmentation prediction for the image are obtained, and
when a query image is provided with a pre-learned model, the model is learned based on the image and a segmentation index to simultaneously perform classification and segmentation of a specific region from the query image, and
the model includes an attentive squeeze network (ASNet), does not perform the classification when an object with low relevance exists in the query image, and performs the classification and segmentation when an object with high relevance exists in the query image.

11. The image processing system of claim 10, wherein an integrative few-shot learning (iFSL) method is applied to the learning of the model, and
in the integrative few-shot learning, the model is learned to identify a subset appearing in the query image and predict a set of problem segmentation masks corresponding to the class.

12. The image processing system of claim 10, wherein the model calculates a correlation tensor between a plurality of images and generates a classification map by passing the correlation tensor through a strided self-attention layer.

13. The image processing system of claim 12, wherein the ASNet includes an attentive squeeze layer (AS layer), and
the AS layer is prepared as a high-order self-attention layer and returns a correlation expression of different levels based on the correlation tensor.

14. The image processing system of claim 13, wherein the ASNet has, as input, hyper-correlation which is a pyramid-shaped cross-correlation tensor between the query image and the support image.

15. The image processing system of claim 11, wherein in integrated few-shot learning, inference is performed using max pooling.

16. The image processing system of claim 11, wherein in the integrated few-shot learning, a classification loss and a segmentation loss are used, and a learner is trained using a class tag or a segmentation annotation.

17. The image processing system of claim 16, wherein the classification loss is an average binary cross-entropy between a spatially averaged pooled class score and a correct answer class label.

18. The image processing system of claim 16, wherein the segmentation loss is an average cross-entropy between a class distribution of an individual position and an actual segmentation annotation.
